(19) United States
(12) Patent Application Publication
(10) Pub. No.: US 2017/0300863 A1
(43) Pub. Date: Oct. 19, 2017

(54) GENERATING RECOMMENDATIONS USING A HIERARCHICAL STRUCTURE

(71) Applicant: LinkedIn Corporation, Mountain View, CA (US)

(72) Inventors: Jian Wang, Los Altos, CA (US); Krishnaram Kenthapadi, Sunnyvale, CA (US); David Hardtke, Oakland, CA (US); Kaushik Ragadurai, Sunnyvale, CA (US)

(21) Appl. No.: 15/218,238

(22) Filed: Jul. 25, 2016

Related U.S. Application Data
(60) Provisional application No. 62/322,115, filed on Apr. 13, 2016.

(51) Int. Cl. G06Q 10/10; G06Q 50/00; H04L 29/08

(52) U.S. Cl. CPC G06Q 10/1053; H04L 67/306; G06Q 50/01; H04L 67/10

(57) ABSTRACT

Apparatuses, computer readable medium, and methods are disclosed for generating job recommendations using a hierarchical Bayesian structure. The method of generating job recommendations includes determining, by at least one hardware processor, first regression coefficients and first hidden feature vector jointly for a first layer based on a member's view behavior, and the member's profile. The method further includes determining, by the at least one hardware processor, second regression coefficients and second hidden feature vector jointly for a second layer based on the first regression coefficients, the first hidden feature vector, and the member's application behavior. The method further includes determining, by the at least one hardware processor, a job recommendation based on one or more job profiles, the first regression coefficients, first hidden feature vector, second regression coefficients, and second hidden feature vector.

### RELATED APPLICATIONS

This application claims the benefit of priority of U.S. Provisional Patent Application Ser. No. 62/322,115, filed Apr. 13, 2016, which is incorporated herein by reference in its entirety

### TECHNICAL FIELD

Embodiments pertain to generating recommendations. Some embodiments relate to determining regression coefficients and hidden feature vectors jointly for each layer of a hierarchical structure based on a previous layer of the hierarchical structure. Some embodiments relate to using member interaction to determine the hierarchical structure and regression coefficients. Some embodiments relate to generating job recommendations for members of a social network system.

### BACKGROUND

Presenting recommendations (e.g., jobs) to members of a social network system can be a valuable service to the member and the employer or recruiter. The job recommendations may help a passive or active job applicant find a job and job recommendations may help employers or recruiters fill open jobs. Determining job recommendations is a computationally demanding when the social network system includes large numbers of members and potentially a large number of jobs. Moreover, displaying bad job recommendations may dissuade a member from using the social network system or turn off job recommendations.

### DESCRIPTION OF THE DRAWINGS

Some embodiments are illustrated by way of example and not limitation in the FIGS. of the accompanying drawings, in which:

FIG. 1 is a block diagram of a social network system in accordance with some embodiments;

FIG. 2 illustrates a job recommendation engine in accordance with some embodiments;

FIG. 3 illustrates dependencies of variables in the hierarchical member interaction structure in accordance with some embodiments;

FIG. 4 illustrates a method for generating job recommendations in accordance with some embodiments;

FIG. 5 illustrates an abbreviated job application description in accordance with some embodiments;

FIG. 6 illustrates an expanded job application description in accordance with some embodiments;

FIG. 7 illustrates a job application in accordance with some embodiments;

FIG. 8 illustrates feedback in accordance with some embodiments; and

FIG. 9 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for improving the generating of job recommendations. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

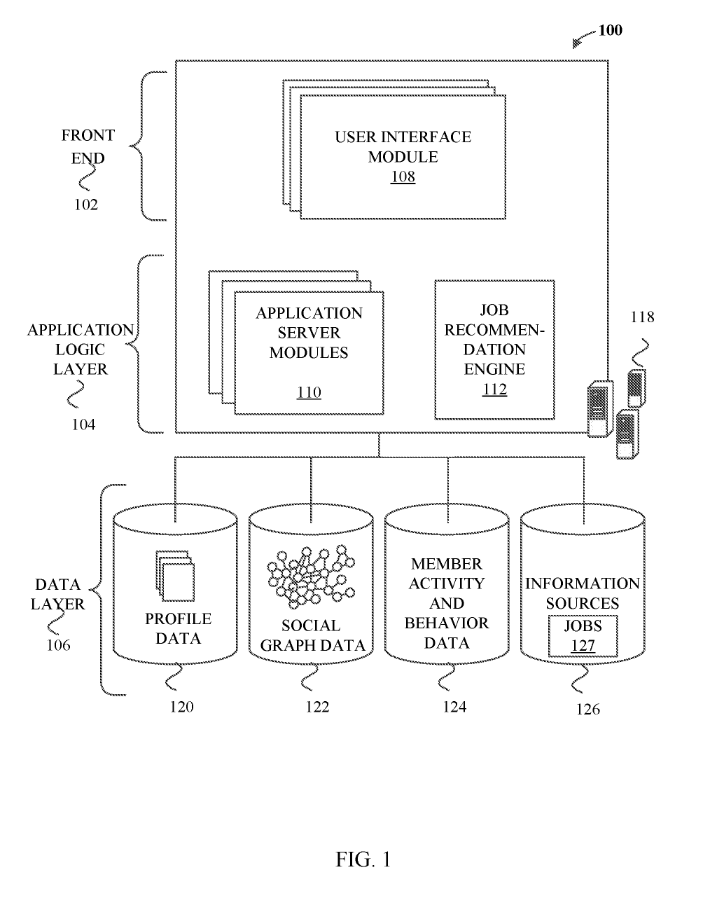

FIG. 1 is a block diagram of a social network system 100 in accordance with some embodiments. The social network system 100 may be based on a three-tiered architecture, comprising a front-end layer 102, application logic layer 104, and data layer 106. Some embodiments implement the social network system 100 using different architectures. The social network system 100 may be implemented on one or more computers 118. The computers 118 may be servers, personal computers, laptops, portable devices, etc. The social network system 100 may be implemented in a combination of software, hardware, and firmware.

As shown in FIG. 1, the front end 102 includes user interface modules 108. The user interface modules 108 may be one or more web services. The user interface modules receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer 106 includes profile data 120, social graph data 122, member activity and behaviour data 124, and information sources 126. Profile data 120, social graph data 122, and member activity and behaviour data 124, and/or information sources 126 may be databases. One or more of the data layer 106 may store data relating to various entities represented in a social graph. In some embodiments, these entities include members, companies, and/or educational institutions, among possible others. Consistent with some embodiments, when a person initially registers to become a member of the social network system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in profile data 120.

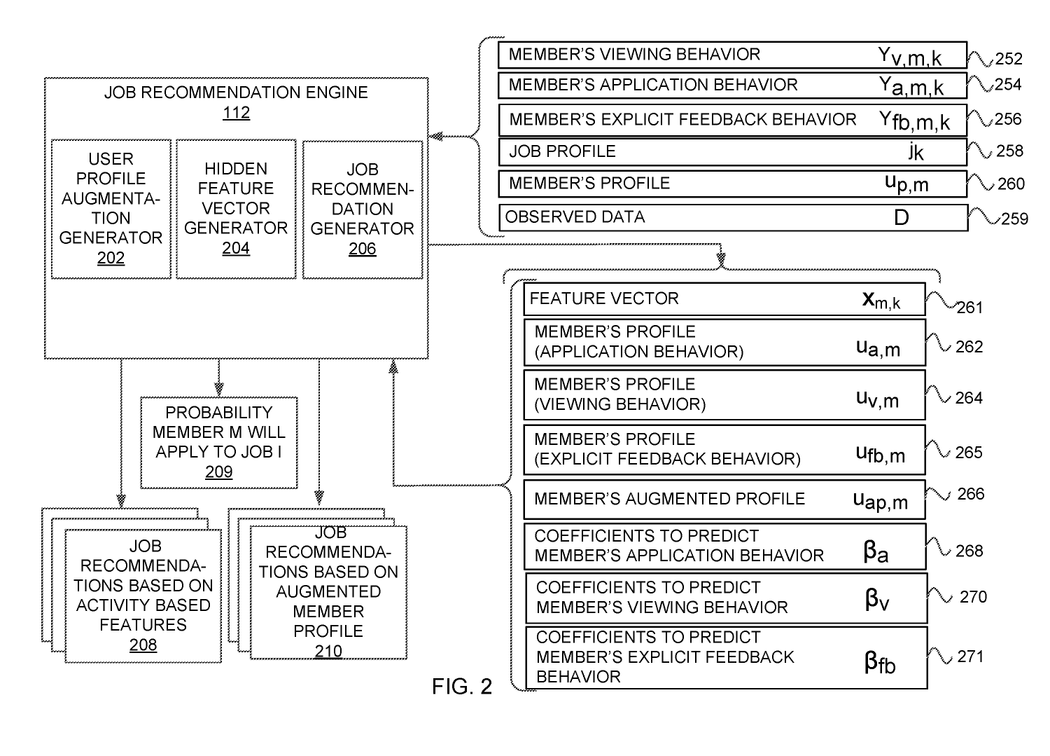

Referring briefly to FIG. 2, the profile data 120 includes, in one embodiment, the member's profile u_{p,m} 260, member's profile (application behaviour) u_{a,m} 262, member's profile (viewing behaviour) u_{v,m} 264, member profile (explicit feedback behavior) U_{th,m} 265, member's viewing behaviour Y_{v,m,i} 252, member's application behavior Y_{a,m,k} 254, member's explicit feedback behaviour Y_{th,m,k} 256, coefficients to predict member's application behaviour βₐ 268, coefficients to predict member's application behaviour βᵥ 270, and coefficients to predict member's explicit feedback behaviour β_{fb} 271.

With some embodiments, a member's profile data will include not only the explicitly provided data, but also any number of derived or computed member profile attributes and/or characteristic, which may become part of one of more of profile data 120, social graph data 122, member activity and behaviour data 124, and/or information sources 126.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data 122. With some embodiments the social graph data 122 may be implemented with a graph database, which is a particular type of database that uses graph structures with nodes, edges, and properties to represent and store data. In this case, the social graph data 122 reflects the various entities that are part of the social graph, as well as how those entities are related with one another.

With various alternative embodiments, any number of other entities might be included in the social graph data 122, and as such, various other databases may be used to store data corresponding with other entities. For example, although not shown in FIG. 1, consistent with some embodiments, the system may include additional databases for storing information relating to a wide variety of entities, such as information concerning various online or offline people, job announcements, companies, groups, posts, slideshares, and so forth.

With some embodiments, the application server modules 110 may include one or more activity and/or event tracking modules, which generally detect various user-related activities and/or events, and then store information relating to those activities/events in, for example, member activity and behaviour data 124. For example, the tracking modules may identify when a user makes a change to some attribute of his or her member profile, or adds a new attribute. Additionally, a tracking module may detect the interactions that a member has with different types of content. For example, a tracking module may track a member's activity with respect to job announcements, e.g. job announcement views, saving of job announcements, applications to a job in a job announcement, explicit feedback regarding a job announcement (e.g., not interested, not looking, too junior, not qualified, information regarding the job the member would like, a location member wants to work, do not want to move, more like this, etc.), job search terms that may be entered by a member to search for job announcements. Such information may be used, for example, by one or more recommendation engines to tailor the content presented to a particular member, and generally to tailor the user experience for a particular member.

Information sources 126 may be one or more additional information sources. For example, information sources 126 may include ranking and business rules, historical search data, and reference data as well as people, jobs 127, which may include job announcements (not illustrated), etc.

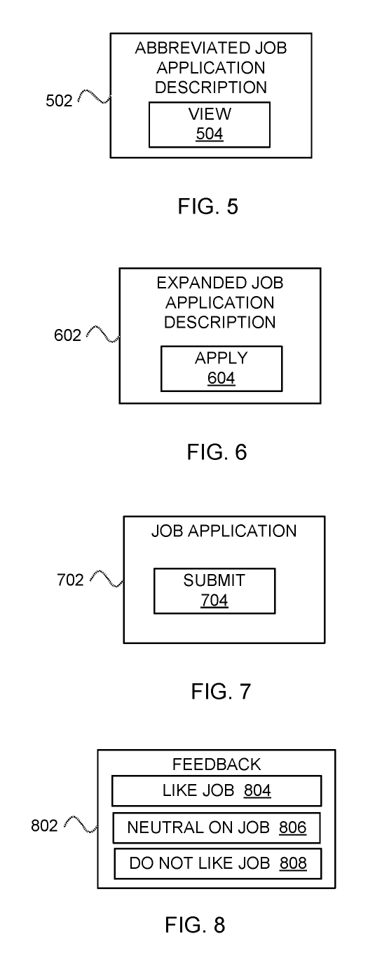

The application server modules 110, which, in conjunction with the user interface module 108, generate various user interfaces (e.g., web pages) with data retrieved from the data layer 106. In some embodiments, individual application server modules 110 are used to implement the functionality associated with various applications, services and features of the social network service. For instance, a messaging application, such as an email application, an instant messaging application, or some hybrid or variation of the two, may be implemented with one or more application server modules 110. Of course, other applications or services may be separately embodied in their own application server modules 110. In some embodiments applications may be implemented with a combination of application service modules 110 and user interface modules 108. For example, a job recommendation engine 112 may be implemented with a combination of back-end modules, front-end modules, and modules that reside on a user's computer 118. For example, the social network system 100 may download a module to a web browser running on a user's computer 118, which may communicate with a module running on a server 118 which may communicate with a module running on a back-end database server 118. As an example, FIGS. 5-8 may be generated on a member's computer in this way.

The social network system 100 may provide a broad range of applications and services that allow members the opportunity to share and receive information, often customized to the interests of the member. For example, with some embodiments, the social network system 100 may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in social graph data 122. When a member joins a group, his or her membership in the group may be reflected in the social graph data 118. In some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and structured with the social graph data 118.

In addition to the various application server modules 110, the application logic layer includes a job recommendation engine 112. As illustrated in FIG. 1, with some embodiments, the job recommendation engine 112 is implemented as a service that operates in conjunction with various application server modules 110 and user interface modules 108. For instance, any number of individual application server modules 110 can invoke the functionality of the job recommendation engine 112. However, with various alternative embodiments, the job recommendation engine 112 may be implemented as its own application server module 110 such that it operates as a stand-alone application.

The job recommendation engine 112 may search the data layer 106 and determine jobs 127 to present to a member. In some embodiments, the job recommendation engine 112 may determine jobs 127 that should not be presented to a member. In some embodiments, the job recommendation engine 112 works offline to prepare jobs 127 to present to a member. In some embodiments, the job recommendation engine 112 may be used by a recruiter to generate a list of members that may be interested in a particular job 127. The recruiter may pay to push the job 127 to the member or members.

With some embodiments, the job recommendation engine 112 may include or have an associated publicly available application programming interface (API) that enables third-party applications to invoke the functionality of the job recommendation engine 112.

As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the disclosed embodiments are by no means limited to such architecture.

FIG. 2 illustrates a job recommendation engine 112 in accordance with some embodiments. Illustrated in FIG. 2 is job recommendation engine 112, member's viewing behaviour Y_{v,m,l} 252, member's application behavior Y_{a,m,k} 254, member's explicit feedback behaviour Y_{fb,m,k} 256, job profile Jᵢ 258, member's profile u_{p,m} 260, member's profile (application behavior) u_{a,m} 262, member's profile (viewing behaviour) u_{v,m} 264, observed data 259 member's profile (feedback behavior) u_{fb,m} 265, member's augmented profile u_{ap,m} 266, coefficients to predict member's application behaviour βₐ 268, coefficients to predict member's application behaviour βᵥ 270, coefficients to predict member's explicit feedback behaviour β_{fb} 271, job recommendations based on activity based features 208, probability member M will prefer job I 209, and job recommendations based on augmented member profile 210.

Lowercase M is used to indicate the index of the member for 1,2, . . . , M members. Lowercase K is used to indicate the index of the job for 1,2, . . . , N jobs.

In some embodiments, the member's viewing behaviour Y_{v,m,k} 252 indicates the member's viewing behaviour for job k, where m=1, 2, . . . , M is the index of the member, and k=1, 2, . . . , N is the index of the job. For example, if Y_{v,m,k}=1, it indicates that member m clicked to view job k otherwise Y_{v,m,k}=−1. The member's viewing behaviour Y_{v,m,k} 252 may be stored as part of the member activity and behaviour data 124.

In some embodiments, the member's application behaviour Y_{a,m,k} 254 indicates the member's application behaviour for job k. If Y_{a,m,k}=1, it indicates that the member m clicked to apply to job k otherwise Y_{a,m,k}=−1. The member's application behaviour Y_{a,m,k} 254 may be stored as part of the member activity and behaviour data 124.

In some embodiments, the job profile jₖ 258 is the vector fields or features associated with job k. The vector includes static features that are derived from the job description, e.g. job title, qualifications, job location, etc. The job profile jₖ 258 may be stored in information sources 126. The job profile jₖ 258 is a profile of a job 127, which, in some embodiments, has one or more job announcements associated with the job profile jₖ 258 or job 127. Table 1 illustrates example fields of the job profile jₖ 258.

TABLE 1
EXAMPLE JOB PROFILE FIELDS

<targetField entityType=″JOB″ name=″listingType″/>
<targetField entityType=″JOB″ name=″normalizedTitleSeniorityYears″/>
<targetField entityType=″JOB″ name=″industryCategory″/>
<targetField entityType=″JOB″ name=″companySize″/>
<targetField entityType=″JOB″ name=″standardizedLocations″/>
<targetField entityType=″JOB″ name=″standardizedLocations″/>
<targetField entityType=″JOB″ name=″jobSeniorityv2″/>
<targetField entityType=″JOB″ name=″geo_country″/>
<targetField entityType=″JOB″ name=″skills″>
<targetField entityType=″JOB″ name=″description″>
<targetField entityType=″JOB″ name=″companyDesc″>
<targetField entityType=″JOB″ name=″functionsv2″>
<targetField entityType=″JOB″ name=″jobSeniorityv2″>
<targetField entityType=″JOB″ name=″standardizedSkillsStringV3″>
<targetField entityType=″JOB″ name=″standardizedSkillsV3″>
<targetField entityType=″JOB″ name=″jobTitlev2″>
<targetField entityType=″JOB″ name=″titleString″>
<targetField entityType=″JOB″ name=″standardizedLocations″>
<targetField entityType=″JOB″ name=″industryCategory″>

In some embodiments, the member's profile u_{p,m} 260 is a vector of profile-based features associated with user m. The vector includes static demographic features that are derived from the user profile information. The member's profile u_{p,m} 260 may be stored in the profile data 120.

Table 2 is an example of member's profile u_{p,m} 260 fields.

TABLE 2
EXAMPLE MEMBER PROFILE FIELDS

<sourceField entityType=″MEMBER″ name=″associations″>
<sourceField entityType=″MEMBER″ name=″currentFunctionsV2″>
<sourceField entityType=″MEMBER″
name=″currentNormalizedTitleSeniorityYears″/>
<sourceField entityType=″MEMBER″ name=″currentPosSummary″>
<sourceField entityType=″MEMBER″ name=″currentTitleSimTopK″>
<sourceField entityType=″MEMBER″ name=″currentTitleString″>
<sourceField entityType=″MEMBER″ name=″currentTitleV2″>
<sourceField entityType=″MEMBER″
name=″CustomPlusLatentPreferences.LOCATION″>
<sourceField entityType=″MEMBER″
name=″CustomPlusLatentPreferences.SENIORITY″>
<sourceField entityType=″MEMBER″ name=″degrees″>
<sourceField entityType=″MEMBER″ name=″eduNotes″>
<sourceField entityType=″MEMBER″ name=″headline″>
<sourceField entityType=″MEMBER″ name=″honors″>
<sourceField entityType=″MEMBER″ name=″interests″>
<sourceField entityType=″MEMBER″ name=″jobSeniorityV2″>
<sourceField entityType=″MEMBER″ name=″pastFunctionsV2″>
<sourceField entityType=″MEMBER″ name=″pastPosSummary″>
<sourceField entityType=″MEMBER″ name=″pastTitleString″>
<sourceField entityType=″MEMBER″ name=″pastTitlesV2″>
<sourceField entityType=″MEMBER″ name=″placeSimTopK″>
<sourceField entityType=″MEMBER″
name=″Preferences.COMPANY_SIZE/>
<sourceField entityType=″MEMBER″
name=″Preferences.INDUSTRY_CATEGORY″/>
<sourceField entityType=″MEMBER″ name=″Preferences.LOCATION″/>
<sourceField entityType=″MEMBER″ name=″Preferences.SENIORITY/>
<sourceField entityType=″MEMBER″
name=″Resolved.COMPANY_SIZE″>
<sourceField entityType=″MEMBER″ name=″Resolved.COUNTRY″/>
<sourceField entityType=″MEMBER″
name=″Resolved.INDUSTRY_CATEGORY″>
<sourceField entityType=″MEMBER″ name=″standardizedSkillsStringV3″>
<sourceField entityType=″MEMBER″ name=″standardizedSkillsV3″>
<sourceField entityType=″MEMBER″ name=″summary″>

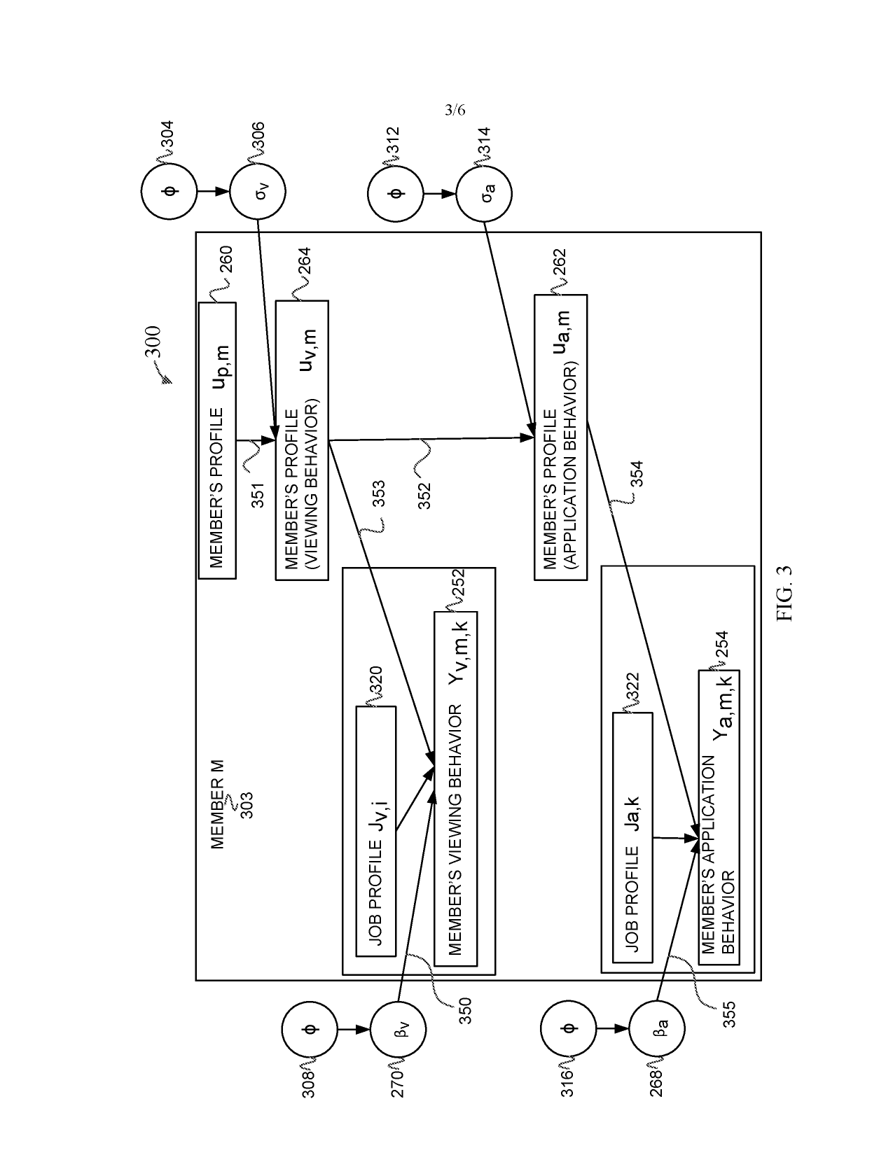

In some embodiments, the member's profile (application behaviour) u_{p,m} 262 is a vector of application-based features associated with member m. The vector is tuned according to the member's application behaviour. For example, in some embodiments, the hidden feature vector generator 204 generates the member's profile (application behaviour) u_{a,m} 262 based on the member's profile u_{p,m} 260 and Y_{a,m,k} that indicates the user's application behaviour for job k. In some embodiments, if Y_{a,m,k}=1, it indicates that the member m clicked to apply to job k. The member's profile (application behaviour) u_{a,m} 262 may be stored in the profile data 120. In some embodiments, σₐ is the variance of the member's profile (application behaviour) u_{a,m} 262, which may be determined by the job recommendation engine 112. In some embodiments, the job recommendation engine 112 tunes σₐ to affect the influence of the member's profile (application behaviour) u_{a,m} 262 on a next step of a hierarchical approach. In some embodiments, the hidden feature vector generator 204 generates the member's profile (application behaviour) u_{a,m} 262 based on one or more of the member's profile u_{p,m} 260, the member profile (viewing behavior) u_{v,m} 264, member's application behavior Y_{a,m,k} 254, and the member's viewing behavior Y_{v,m,k} 252. For example, as disclosed in conjunction with FIG. 3, the hidden feature vector generator 204 generates member's profile (viewing behavior) u_{v,m} 264 based on the member's profile u_{p,m} 260 and the member's viewing behavior Y_{v,m,k} 252. Additionally, the hidden feature vector generator 204 generates member's profile (application behavior) u_{a,m} 262 based on the member's profile (viewing behavior) u_{v,m} 264 and the member's application behavior Y_{a,m,k} 254. The hidden feature vector generator 204, in some embodiments, generates member's profile (explicit feedback behavior) based on the member's profile (application behavior) u_{a,m} 262 and the member's application behavior Y_{fb,m,k} 256.

In some embodiments, the member's profile (viewing behaviour) u_{v,m} 264 is a vector of view-based features associated with user m. The vector is tuned according to the user's viewing behaviour (e.g., member's viewing behaviour Y_{v,m,k} 252). For example, in some embodiments, the hidden feature vector generator 204 generates the member's profile (viewing behaviour) u_{v,m} 264 based on the member's profile u_{p,m} 260 and the member's viewing behaviour Y_{v,m,i} 252. The member's profile (viewing behaviour) u_{v,m} 264 is stored in the profile data 120, in accordance with some embodiments. In some embodiments, σᵥ is the variance of the member's profile (viewing behaviour) u_{v,m} 264.

In some embodiments, the feature vector X_{m,k} 261 is a feature vector that is associated with member profile m and job k. In some embodiments, the feature vector X_{m,k} 261 includes fields from the member's profile u_{p,m} 260, fields from the job profile jₖ 258, and similarity-based features between the member's profile u_{p,m} 260 the job profile jₖ 258. The feature vector X_{m,k} 261 is stored in the profile data 120, in accordance with some embodiments.

In some embodiments, observed data D 259 is observed data of all members, e.g., D={D₁, . . . , Dₘ, . . . , D_{M}}. The observed data D 259 is stored in the member activity and behaviour data 124 in accordance with some embodiments.

In some embodiments, Dₘ={Y_{v,m,k}, Y_{a,m,k}, u_{p,m}, jₖ} is a set of observed data associated with user m. Each observation is associated with four parts: member's viewing behaviour Y_{v,m,k} 252, member's application behaviour Y_{a,m,k} 254, member's profile u_{p,m} 260, and job profile jₖ 258. The Dₘ is stored in the member activity and behaviour data 124 in accordance with some embodiments.

In some embodiments, the member's profile (explicit feedback behavior) u_{ap,m} 265 is a vector of feedback-based features associated with user m. The vector is tuned according to the user's feedback behaviour. For example, in some embodiments, the hidden feature vector generator 204 generates the member's profile (explicit feedback behavior) u_{ap,m} 265 based on the member's profile u_{p,m} 260 and the member's explicit feedback behaviour Y_{fb,m,k} 256. The member's profile (explicit feedback behavior) u_{ap,m} 265 may be stored in the profile data 120.

In some embodiments, the member's augmented profile u_{ap,m} 266, is member's profile u_{p,m} 260 augmented with one or more of member's profile (application behavior) u_{a,m} 262, member's profile (viewing behavior) u_{v,m} 264, and member's profile (explicit feedback behavior) u_{ap,m} 265. The user profile augmentation generator 202 is configured to generate the member's augmented profile u_{ap,m} 266 from the member's profile u_{p,m} 260 augmented with one or more of the member's profile (viewing behaviour) u_{v,m} 264, the member's profile (viewing behaviour) u_{v,m} 264, or the member's profile (explicit feedback behavior) u_{ap,m} 265. The member's augmented profile u_{ap,m} 266 may be stored in the member activity and behavior data 124.

In some embodiments, the coefficients to predict member's application behaviour βₐ 268 is a d-dimensional vector of regression coefficients to predict the user's application behaviour Y_{a,m,k} 254. In some embodiments, the coefficients to predict member's application behaviour βₐ 268 is generated by the job recommendation engine 112. The coefficients to predict member's application behaviour βₐ 268 may be stored in the member activity and behavior data 124.

In some embodiments, the coefficients to predict member's viewing behaviour βᵥ 270 is a d-dimensional vector of regression coefficients to predict the user's viewing behaviour Y_{v,m,i} 252. In one embodiment, the coefficients to predict member's viewing behaviour βᵥ 270 is generated by the job recommendation engine 112. The coefficients to predict member's viewing behaviour βᵥ 270 may be stored in the member activity and behavior data 124.

In some embodiments, the coefficients to predict member's explicit feedback behaviour β_{fb} 271 is a d-dimensional vector of regression coefficients to predict user's explicit feedback behavior Y_{fb,m,k} 256. In one embodiment, the coefficients to predict user's explicit feedback behavior Y_{fb,m,k} 256 is generated by the job recommendation engine 112. The coefficients to predict user's explicit feedback behavior Y_{fb,m,k} 256 may be stored in the member activity and behavior data 124.

The job recommendations based on activity based features 208 are generated by the job recommendation generator 206 where jobs 127 are selected based on one or more of the coefficients to predict member's application behaviour βₐ 268, the coefficients to predict member's viewing behaviour βᵥ 270, and the coefficients to predict member's explicit feedback behaviour β_{fb} 271. The job recommendations based on activity based on augmented member profile 210 are generated by the job recommendation generator 206 where jobs 127 are selected based on one or more of the member's augmented profile u_{ap,m}, coefficients to predict member's application behaviour βₐ 268, the coefficients to predict member's viewing behaviour βᵥ 270, and the coefficients to predict member's explicit feedback behaviour β_{fb} 271.

The probability member M will apply to job I 209 may be determined by the job recommendation engine 112 based on one or more of the member's augmented profile u_{ap,m,} coefficients to predict member's application behaviour βₐ 268, the coefficients to predict member's viewing behaviour βᵥ 270, and the coefficients to predict member's explicit feedback behaviour β_{fb} 271.

Hidden feature vector generator 114 generates hidden variables (e.g., Equation (6) θ={θ₁, θ₂, . . . , θ_{M}}). In some embodiments, user profile augmentation generator 202 augments a member's profile u_{p,m} 260 with the hidden variables to generate member's augmented profile u_{ap,m} 266, which is substituted for the member's profile u_{p,m} 260.

FIG. 3 illustrates dependencies of variables 300 in the hierarchical member interaction structure in accordance with some embodiments. Illustrated in FIG. 3 is φ 304, σᵥ 306, φ 312, σₐ 314, φ 308, coefficients to predict member's viewing behavior βᵥ 270, φ 316, coefficients to predict member's application behavior βₐ 268, user M 303, member's profile u_{p,m} 260, member's profile (viewing behaviour) u_{v,m} 264, job profile J_{v,j} 320, member's viewing behaviour Y_{v,m,i} 252, member's profile (application behaviour) u_{a,m} 262, job profile J_{v,j} 322, and member's application behaviour Y_{a,m,k} 254.

The arrows in FIG. 3 indicate that the variable at the origin of the arrow is dependent on the variable at the end of the arrow. For example, arrow 350 indicates that coefficients to predict member's viewing behavior βᵥ 270 is dependent on member's viewing behavior Y_{v,m,i} 252. For example, the coefficients to predict member's viewing behavior βᵥ 270 may be determined by the job recommendation engine 112 based on the member's view behavior Y_{v,m,i}.

In some embodiments the job recommendation engine 112 structures the parameters as follows. The σᵥ is the variance of the member's profile (viewing behaviour) u_{v,m} 264. The σₐ is the variance of the member's profile (application behaviour) u_{a,m} 262. M is the member M 303. The φ's 304, 308, 312, 316=(μ_{β}_{ᵥ}, σ_{β}_{ᵥ}, μ_{β}_{ₐ}, σ_{β}_{ₐ}, μ_{σ}_{ᵥ}, σ_{σ}_{ᵥ}, μ_{σ}_{ₐ}, σ_{σ}_{ₐ}). The Gy 306 is the variance of distribution where member's profile (viewing behavior) u_{v,m} is drawn from. The σₐ 314 is the variance of the distribution where member's profile (application behavior) u_{v,m} is drawn from. In some embodiments, the job recommendation engine 112 assumes that the parameters are drawn from a Gaussian distribution. For example, Equations (1a), (1b), (1c), and (1d):

βᵥ˜N(μ_{β}_{ᵥ}, σ_{β}_{ᵥ}); Equation (1a):

βₐ˜N(μ_{β}_{ₐ}, σ_{β}_{ᵥ}); Equation (1b):

σᵥ˜N(μ_{σ}_{ᵥ}, σ_{β}_{ᵥ}); Equation (1c):

σₐ˜N(μ_{σ}_{ₐ}, σ_{β}_{ᵥ}); Equation (1d):

In some embodiments the job recommendation engine 112 structures the user feature vectors as follows. The job recommendation engine assumes that the member's profile (viewing behaviour) u_{v,m} 264 follows a Gaussian distribution with member's profile u_{p,m} 260 as the mean and σᵥ as the variance. The job recommendation engine 112, in some embodiments, assumes that member's profile (application behaviour) u_{a,m} 262 follows a Gaussian distribution with the member's profile (viewing behaviour) u_{v,m} 264 as the mean and ρᵥ as the variance. These relationships are described in Equations (2a) and (2b).

u_{v,m}˜N(u_{p,m}, σᵥ); and Equation (2a):

u_{a,m}˜N(u_{v,m}, σₐ). Equation (2b):

In some embodiments, the job recommendation engine 112 tunes σᵥ and σₐ to control the weight of the prior fields that come from the member's profile u_{p,m} 260 fields. The higher the variance σᵥ, the less important the member's profile u_{p,m} 260 fields (e.g., the less important the dependency is expressed by arrow 351). The job recommendation engine 112 can give more weight to the member's profile (viewing behaviour) u_{v,m} 264 and less weight to the member's profile u_{p,m} 260 fields by adjusting σᵥ.

The higher the variance σₐ, the less important the member's profile (viewing behavior) u_{v,m} 264 fields (e.g., the less important the dependency that is expressed by arrow 352). The job recommendation engine 112 can give more weight to the member's profile (application behaviour) u_{a,m} 262 and less weight to the member's profile u_{p,m} 260 fields and member's profile (viewing behaviour) u_{v,m} 264 by adjusting σₐ.

The user interaction signal may be structured by the job recommendation engine 112 as follows. The member's viewing behaviour Y_{v,m,k} 252 is dependent on (arrow 253) member's profile (viewing behaviour) u_{v,m} 264 fields and dependent on (arrow 350) member's viewing behaviour βᵥ 270. The member's application behaviour Y_{a,m,k} 254 is dependent on (arrow 354) the member's profile member's profile (application behaviour) u_{a,m} 262 and is dependent on (arrow 355) the coefficients to predict member's application behaviour βₐ 268.

In some embodiments, the job recommendation engine 112 uses logistic regression to predict member action as described in Equations (3a) and (3b).

Equation (3a): p(y_{v,m,k}|u_{v,m,}βᵥ)=1/(1+exp(−y_{v,m,k}(βᵥ^{T}f(jₖ, u_{v,m})))), where Equation (3a) expresses the probability of y_{v,m,k} given u_{v,m}, and, βᵥ; and βᵥ^{T} are the coefficients to predict member's viewing behavior βᵥ 270 transposed (T).

Equation (3b): p(y_{a,m,k}|u_{a,m}, βₐ)=1/(1+exp(−y_{a,m,k}(β_{α}^{T}f(jₖ, u_{a,m})))), where Equation (3b) expresses the probability of y_{a,m,k} given u_{a,m} and β_{α}; and, β_{α}^{T} are the coefficients to predict member's application behavior βa 268 transposed (T).

In some embodiments, the job recommendation engine 112 assumes that the data is independent identically distributed to represent the data likelihood as in Equation (4).

Equation (4): p(D|φ))=∫p(D, θ_{g}|φ)dθ_{g}=∫p(D|θ_{g}, φ)p(θ_{g}|φ)dθ_{g}=∫[πₘ₌₁^{M}p(yₘ|θ_{g}φ)]p(θ_{g}|φ)dθ_{g}, where θ_{g}=β_{α}, βᵥ, σₐ, σᵥ, and θ_{g} is a random variable denoting the joint distribution of the global random variables, β_{α}, βᵥ, σₐ, σᵥ.

The job recommendation engine 112 may determine the data likelihood for member m as follows: Equation (5): p(yₘ|θ_{g}, φ)=∫p(yₘ|θₘ, θ_{g}, φ)* p(θₘ|θ_{g}, φ)dθₘ, where

p(yₘ|θₘ, θ_{g}, φ)* p(θₘ|θ_{g}, φ)=πₖ₌₁^{K}^{ₘ}[p(y_{v,m,k}|u_{v,m}, βᵥ)* p(y_{a,m,k}|u_{a,m}, βₐ)]*

p(u_{a,m}|u_{v,m},σₐ)p(u_{v,m}|σᵥ), where θₘ=(u_{v,m} and u_{a,m}) is a random variable denoting the joint distribution of the view based vector and application based vector random variables for each member m.

The job recommendation engine 112 may maximize the likelihood of p(D, φ), which is equivalent to maximizing the log likelihood of Equation (6): L(D|φ)=ln p (D|φ).

There is no closed form solution to Equations (5) or (6), so, in some embodiments, the job recommendation engine 112 uses a Bayesian method which is an iterative process to find an approximate solution,. The job recommendation engine 112 uses an Estimate (E) step where the regression structure is fixed and the user interaction-based vector is varied, and a Maximizing (M) step where the user interaction-based vector is fixed and the regression structure is varied. The job recommendation engine 112 determines the member's profile (application behavior) u_{a,m} 262, member's profile (viewing behaviour) u_{v,m} 264, member's profile (feedback behavior) u_{ap,m} 265, coefficients to predict member's application behaviour βₐ 268, and coefficients to predict member's application behaviour βᵥ 270 in accordance with Equation (5).

In some embodiments, the iteration process includes a portion for each layer of the hierarchical member interaction structure (see FIG. 3). For example, the job recommendation engine 112 uses an Estimate (E) step where the coefficients to predict member's viewing behaviour βᵥ 270 is fixed and the member's profile (viewing behaviour) u_{v,m} 264 is varied (with the other structure parameters being used including job profile J_{v,j}, member's profile u_{p,m,} variance σᵥ 306, φ304, and φ306) then the job recommendation engine 112 goes through a Maximizing (M) step where coefficients to predict member's viewing behaviour βᵥ 270 is varied and the member's profile (viewing behaviour) u_{v,m} 264 is fixed (with the other structure parameters being used including job profile J_{v,i}, member's profile u_{p,m} , variance σᵥ 306, φ304, and φ306). The job recommendation engine 112 iterates through these steps until they converge on a solution. In some embodiments, during the Maximizing (M) step, other regression structure variables other than the coefficients to predict member's viewing behaviour βᵥ 270 may be varied, e.g. any of the variables associated with φ304 or φ308.

The job recommendation engine 112 may use the Estimate (E) and Maximizing (M) steps for each layer of the hierarchy (see FIG. 3.) For example, the job recommendation engine 112 may determine the coefficients to predict member's viewing behaviour βᵥ 270 and the member's profile (viewing behaviour) u_{v,m} 264, and then determine member's profile (application behavior) u_{a,m} 262 and coefficients to predict member's application behavior βₐ 268 using the Estimating (E) and Maximizing (M) steps.

In some embodiments, the job recommendation engine 112 may continue the Estimating (E) and Maximizing (M) steps to determine member's profile (explicit feedback behavior) β_{fb,m} 265, and coefficients to predict member's explicit feedback behavior β_{fb} as another layer in the hierarchy as described in conjunction with FIG. 3.

Equation (6): θ={θ₁, θ₂, . . . , θ_{M}}, where θ is a set of hidden variables that, in some embodiments, are generated by the job recommendation engine 112 and represent the latent preferences of member M based on one or more of the member's viewing behavior y_{v,m,i} 252, member's application behavior y_{a,m,k} 254, member's explicit feedback behavior y_{fb,m,k} 256, and job profile Jᵢ 258. The set of hidden variables θ may be used by the job recommendation engine 112 to generate the member's profile (application behavior) u_{a,m} 262, the member's profile (view behavior) u_{v,m} 264, and member's profile (explicit feedback behavior) u_{fb,m} 265.

For example, a member's (m) profile (p) u_{p,m} may include “[title: {software engineer, 1.0}]”. The member may apply (e.g., member's application behavior y_{a,m,k} may be 1 for job k) to a job (e.g., for a job 127 with a job profile Jₖ) that includes “[title: {[program manager, 1.0}]” as part of the job profile Jᵢ. θ may be determined by the job recommendation engine 112 to include “[title: {software engineer, 1.0} {program manager, 1.0}]” as, for example, θ₁. The job recommendation engine 112 may generate the member's profile (application behavior) u_{a,m} 262 to include θ₁. The user profile augmentation generator 202 may generate the member's augmented profile u_{ap,m} 266, the member's profile (application behavior) u_{a,m} 262, and/or the member's profile (view behavior) u_{v,m} 264 to include θ₁. The job recommendation engine 112 may now start to recommend jobs with “title: program manager”.

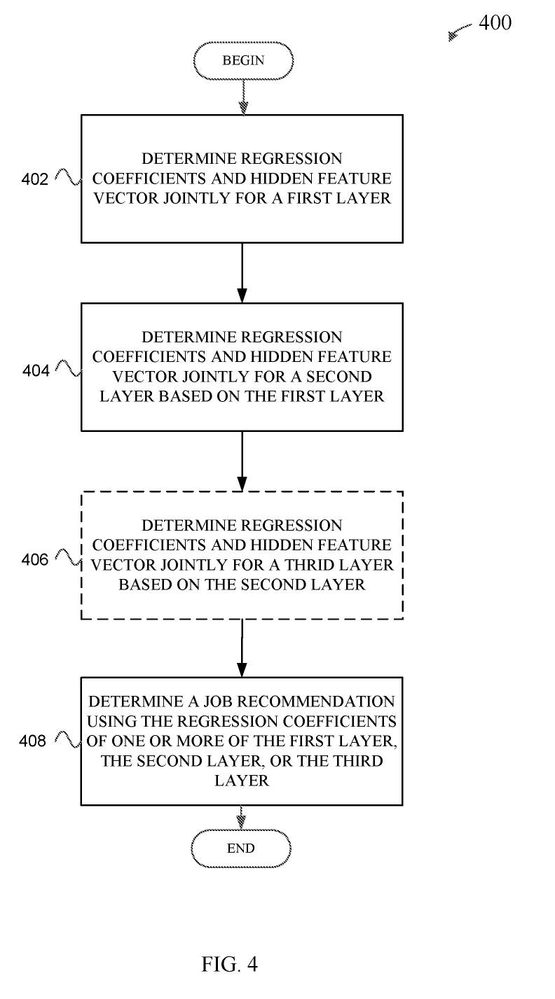

FIG. 4 illustrates a method 400 for generating job recommendations in accordance with some embodiments. The method 400 begins at operation 402 with determining regression coefficients and hidden feature vector jointly for a first layer. For example, the job recommendation engine 112 determines member's profile (viewing behavior) u_{v,m} 264 and coefficients to predict member's view behavior βᵥ 270 jointly.

The job recommendation engine 112 uses member's viewing behavior Y_{v,m,j} 252 to determine member's profile (viewing behavior) u_{v,m} 264 and to determine coefficients to predict member's view behavior βᵥ 270. The job recommendation engine 112 generates the variance σᵥ 306 from the member's profile (viewing behavior) u_{v,m} 264. The job recommendation engine 112 may operate in accordance with Equations (5) and (6) to determine the member's profile (viewing behavior) u_{v,m} and coefficients to predict member's view behavior βᵥ 270 jointly, where the job recommendation engine 112 may switch between E and M steps as described above to arrive at estimates of the member's profile (viewing behavior) u_{v,m} 264 and coefficients to predict member's view behavior βᵥ 270.

The method 400 continues at operation 404 with determine regression coefficients and hidden feature vector jointly for second layer based on the first layer. For example, the job recommendation engine 112 uses an Estimate (E) step where the coefficients to predict member's application behavior βₐ 268 is fixed and the member's profile (application behavior) u_{a,m} 262 is varied (with the other structure parameters being used including job profile Jᵢ 322, member's profile u_{v,m} 264, variance σₐ 314, φ312). Then, the job recommendation engine 112 goes through a Maximizing (M) step where coefficients to predict member's application behaviour βₐ 268 is varied and the member's profile (application behavior) u_{a,m} 262 is fixed. One or more may of the following may be used by the job recommendation engine 112 during the M step: job profile Jᵢ 322, member's profile (viewing behavior) u_{v,m} 264, variance σₐ 314, and φ312. The job recommendation engine 112 iterates through the E and M steps until an approximate solution is found based on equations (5) and (6). In some embodiments, the member's profile (application behaviour) u_{a,m} 262 is determined from the member's profile (viewing behavior) u_{v,m} 264.

Optionally, the method 400 continues at operation 406 with determining regression coefficients and hidden feature vector for a third layer. For example, the job recommendation engine 112 determines member's profile (explicit feedback behavior) u_{fb,m} 265 and coefficients to predict member's feedback behavior β_{fb} 271 jointly.

For example, the job recommendation engine 112 uses an Estimate (E) step where the coefficients to predict member's feedback behavior β_{fb} 271 is fixed and the member's profile (explicit feedback behavior) u_{fb,m} 265 is varied (with the other structure parameters being used including job profile Jᵢ 322, member's profile u_{a,m} 262, a variance σ of the member's profile (explicit feedback behavior) u_{fb,m} 265, and φ of member's profile u_{fb,m} 265). Then, the job recommendation engine 112 goes through a Maximizing (M) step where coefficients to predict member's feedback behavior β_{fb} 271 is varied and the member's feedback behavior β_{fb} 271 is fixed. One or more may of the following may be used by the job recommendation engine 112 during the M step: job profile Jᵢ 322, member's profile u_{a,m} 262, a variance σ of the member's profile (explicit feedback behavior) u_{fb,m} 265, and φ of member's profile u_{fb,m} 265.

The job recommendation engine 112 iterates through the E and M steps until an approximate solution is found based on equations (5) and (6). In some embodiments, the member's profile (explicit feedback behavior) u_{fb,m} 265 is determined from the member's profile (application behavior) u_{a,m} 262.

In some embodiments, the job recommendation engine 112 uses member's application behavior Y_{fb,m,k} 256, member's profile (viewing behavior) u_{v,m} 264, member's profile (application behavior) u_{a,m} 262, coefficients to predict member's view behavior βᵥ 270, and coefficients to predict member's application behavior βₐ 268 to determine member's profile (explicit feedback behavior) u_{fb,m} 265 and to determine coefficients to predict member's application behavior β_{fb} 271. In some embodiments, the job recommendation engine 112 generates the variance σ_{fb} from the member's profile (explicit feedback behavior) u_{fb,m} 265.

The method 400 continues at operation 408 with determining a job recommendation using the regression coefficients of one or more of the first layer, the second layer, or the third layer. For example, the job recommendation generator 206 uses one or more of the job profile Jᵢ 258, member's profile (application behavior) u_{a,m} 262, member's profile (viewing behaviour) u_{v,m} 264, member's profile (explicit feedback behavior) u_{fb,m} 265, member's profile (feedback behavior) u_{ap,m} 265, member's augmented profile u_{ap,m} 266, coefficients to predict member's application behaviour βₐ 268, coefficients to predict member's application behaviour βᵥ 270, and coefficients to predict member's explicit feedback behaviour βₜₕ 271, to evaluate jobs 127 and generate job recommendations based on activity based features 208 and job recommendations based on augmented member profile 210.

In another example, the job recommendation generator 206 evaluates one or more job profiles Jᵢ using the member's profile (application behavior) u_{a,m} 262 and the coefficients to predict member's application behavior βₐ 268. The result is one or more probabilities that member m will prefer job I 209. In another example, the job recommendation generator 206 evaluates one or more job profiles Jᵢ 322 using the member's profile (viewer behavior) u_{v,m} 264 and the coefficients to predict member's viewer behavior βᵥ 350. The result is one or more probabilities that member m will prefer job I 209.

In another example, the job recommendation generator 206 evaluates one or more job profiles Jᵢ 322 using the member's profile (feedback behavior) u_{ap,m} 265 and coefficients to predict member's explicit feedback behaviour β_{fb} 271. The result is one or more probabilities that member m will prefer job I 209. In some embodiments, the method 400 may be applied to different data sets rather than jobs.

In some embodiments, other types of interactions (e.g., saving a job) may be used to determine job recommendations in addition to or instead of views, explicit interactions, and applications. In some embodiments, other types of interactions may form a new layer in the hierarchy to determine job recommendations. In some embodiments, the job recommendation generator 206 may return a list of ranked jobs 127.

FIGS. 5-8 will be described with one another. FIG. 5 illustrates an abbreviated job application description 502 in accordance with some embodiments. FIG. 6 illustrates an expanded job application description 602 in accordance with some embodiments. FIG. 7 illustrates a job application 702 in accordance with some embodiments. FIG. 8 illustrates feedback 802 in accordance with some embodiments. The member m is presented with an abbreviated job application description 502 of a job profile jᵢ and a view 504 button. The job 127 of the job profile jᵢ is selected by the job recommendation engine 112 based on one or more of the methods described herein. The abbreviated job application description 502 is displayed for the member to consume. If the member selects the view 504 button, then the expanded job application description 602 is displayed for the member to consume. The member's viewing behavior Y_{v,m,i} 252 is updated to indicate that the member selected the view 504 button to view job 127. The expanded job application description 602 includes more description regarding the job 127 than the abbreviated job application description 502. If the member selects the apply 604 button, then the job application 702 is displayed for the member's consumption.

The member's application behavior Y_{a,m,k} is updated to indicate that the member has applied to job 127. In some embodiments, the member's application behavior Y_{a,m,k} is not updated until the member selects the submit 704 button. The member may fill out the job application 702 and then submit 704 it. In some embodiments, expanded job application description 602 enables the member to fill out the job application and submit 704 the job application.

In some embodiments, the member may provide feedback 802 at one or more of the stages of applying for a job 127. For example, abbreviated job application description 502 may have a feedback 802 button, expanded job application description 602 may have a feedback 802 button, and/or the job application 702 may have a feedback 802 button. If the member selects a feedback 802, then the member's explicit feedback behavior Y_{fb,m,k} is updated to indicate the feedback provided by the member for the job 127, e.g. like job 804, neutral on job 806, do not like job 808. In some embodiments, different feedback is provided such as (e.g., not interested, not looking, too junior, not qualified, information regarding the job the member would like, a location member wants to work, do not want to move, more like this, etc.).

TABLE 3
Embodiments of the Job Recommendation Engine To Compare

| Structure | User Interaction Signal | Hierarchy or not |
|---|---|---|
| M-baseline | None | None |
| M-view | job views | None |
| M-apply | job applications | None |
| M-view Apply | job views, job applications | Hierarchical structure |

Table 3 illustrates embodiments of the job recommendation engine whose performance are compared. M-baseline is the basic regression structure where coefficients to predict member's application behavior βₐ are determined based on the member's profile u_{p,m} 260.

M-view has an interaction signal of job views. The coefficients to predict application behavior βₐ are determined based on the member's viewing behavior Y_{v,m,l} 252. M-apply has an interaction signal of job applications. The coefficients to predict application behavior βₐ are determined based on the member's application behavior Y_{a,m,I} 254. M-view apply has user interaction signals of job views and job applications and the structure is hierarchical whereas the other structures are not. The coefficients to predict application behavior Pa are determined based on the member's application behavior Y_{a,m,I} 254 and the member's viewing behavior Y_{v,m,I} 252. The method 400 is an example of the M-view apply embodiment. All structures use the same set of features for the core regression structure. Features include those that are extracted from the member profile-based fields (Table 2) and those extracted from the job fields (Table 1) as well as similarity features between member fields and job fields.

TABLE 4
Offline performance analysis of AUC on different
structures and user segments

| | | High | High | Zero | Zero | Zero |
|---|---|---|---|---|---|---|
| | | App, | APP, | App, | App, | App, |
| | | High | Low | High | Low | Zero |
| Structure | all users | APV | APV | View | View | View |
| M-baseline | 0.612 | 0.612 | 0.571 | 0.602 | 0.604 | 0.618 |
| M-view | 0.638 | 0.663 | 0.604 | 0.606 | 0.619 | 0.669 |
| | (+4.2%) | | | | | |
| M-apply | 0.643 | 0.673 | 0.603 | 0.603 | 0.605 | 0.675 |
| | (+5.1%) | | | | | |
| M-view | 0.644 | 0.682 | 0.606 | 0.612 | 0.623 | 0.677 |
| Apply | | | | | | |

The job recommender engine 112 is configured to implement the different structures of Table 3. Table 4 is generated using a real world dataset from LinkedIn® to evaluate the different structures of Table 3. The performance is based on the area under receiver operating characteristic curve (ROC AUC), which represents the quality of the item recommendation system (viewed as a binary classifier, i.e. did the member apply to the job recommendation or not.) In order to build the member job interaction structure, the job application data was randomly sampled. The sample data contains millions of members that applied to a reasonable number of jobs during the sample period. The distribution of both user views and applications follow the power law distribution, which indicates that a few users who applied to or viewed a lot of jobs while a majority of user who applied to/viewed only a few jobs. There are two peaks in the data, which corresponds to users who didn't apply to any jobs that they viewed and users who applied to almost all jobs that they viewed.

Members are classified according to their usage as indicated by the dataset with high application (“APP”) and high application per view rate (“APV”). High APP are members with at least 1 job 127 application while zero APP are members with no applications. High APV (top 25% percentile) are members with higher application per view rate of job applications while low APV (bottom 75% percentile) are members with lower number of applications per view, e.g., High APV members are more likely to select the apply 604 button (FIG. 6). High View are members with a higher number of views. Low view are members with a lower number views. Zero View are members with no views.

Performance Analysis of the systems of Table 3. Significantly better performance is seen from systems that leverage user interaction signals (m-view, m-apply, and m-view apply). Thus it is preferable to leverage the user interaction signal in the system 100. Moreover, the m-view apply system outperforms (see Table 4) all other systems, which indicates the hierarchical system that leverages member interaction (e.g., views, applications, and feedback) outperforms the other systems of Table 3. Moreover, the system 100 that uses m-apply outperforms the system 100 that uses m-view. This indicates that a members' past application behavior gives a more reliable signal of a members' job-seeking intention in the future.

Tables 5 and 6 illustrate a real example of a member profile, their activities and recommendations from each structure. The member works as a business analyst and viewed jobs with title Software Engineer, Product Manager, Business Analyst, Product Manager, and Business Analyst. The member applied to jobs with title Product Manager and Business Analyst.

Some jobs that the member viewed match with their profile information, but not all of them.

TABLE 5
Example of a User Profile and Activities

| User Profile Title | Business Analyst |
|---|---|
| Jobs that are viewed | Software Engineer, Product Manager, |
| by the user | Business Analyst, Product Manager, |
| | Business Analyst |
| Jobs that are applied | Product Manager, Business Analyst |
| by the user | |

Table 6 illustrates an example of recommendations for Table 5 member profile and activities for different embodiments of the job recommendation engine 112. The M-baseline system recommends jobs with the title similar to Business Analyst. The M-baseline system would miss software engineer and product manager.

TABLE 6
Example of Recommendations for Table 3 Member
Profile and Activities for Different Embodiments of
the Job Recommendation Engine

| | |
|---|---|
| M-baseline | Business Analyst, Consultant-Business |
| | Intelligence and Business Analytics, |
| | Data Analyst |
| M-view | Business Analyst, Product Manager, |
| | Software Engineer |
| M-apply | Business Analyst, Product Manager, |
| | Product Manager |
| M-view Apply | Business Analyst, Product Manager, |
| | Software Engineer |

The M-view system recommends jobs that are consistent with the member's viewing behavior while the m-apply system recommends jobs that are consistent with the member's application behavior. The hierarchical structure m-view apply considers signals from both views and applications. The M-view apply system outperforms the m-baseline system, and in this case performs about the same as the m-view system and the m-apply system.

An online evaluation of the user job interaction structure was performed. 5% of members were randomly selected. A significance level of 0.05 with the paired two-tailed t-test is used to compare two structures. The following results were observed for AB testing comparing M-view apply system against the M-baseline system. Job application rate (API)+3.6% and job view rate (VPI)+3.5%. Further, 4.1% more jobs were presented with 7.7% more views and 7.8% more applications. The M-view apply system then performs significantly better than M-baseline system. The M-view apply system is able to learn the member's job seeking intentions.

In some embodiments, high computational requirements are a significant challenge to recommending jobs. For example, in some embodiments M=400 million members, and each member may have 1000 non-zero coefficients on job features, this approach introduces more than 10¹¹ number of features to learn in the structure. The computational requirements may be prohibitive.

In some embodiments, discovering hidden features and augmenting another vector with the hidden features may enable some embodiments to be used with existing infrastructure. For example, by determining hidden features and using them for a next level of computation enables a relatively constant size for the hidden features.

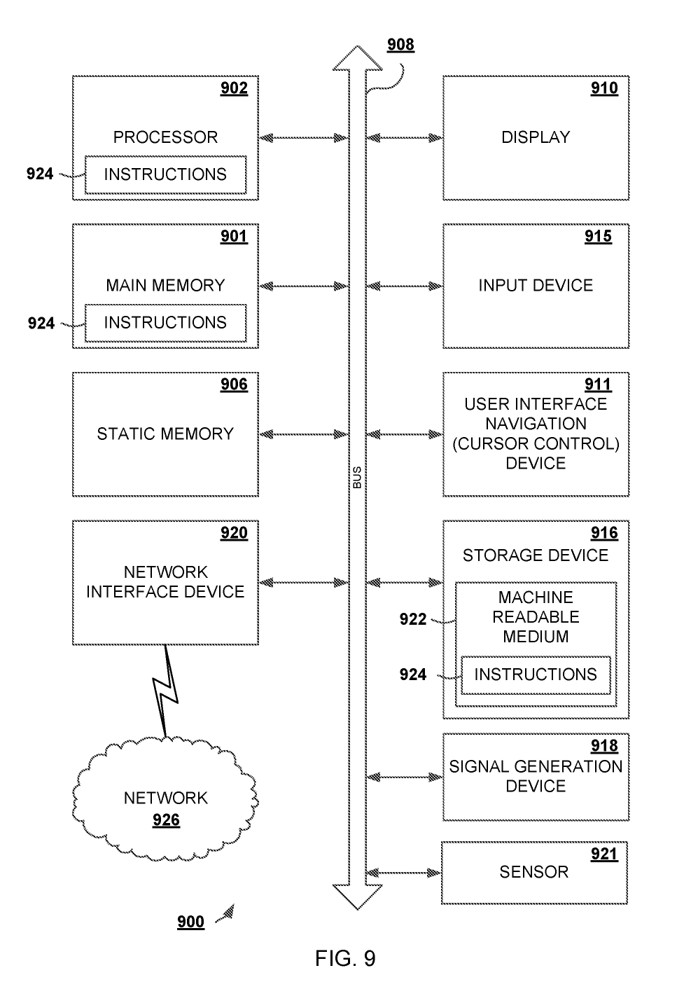

FIG. 9 shows a diagrammatic representation of the machine 900 in the example form of a computer system and within which instructions 924 (e.g., software) for causing the machine 900 to perform any one or more of the methodologies discussed herein may be executed. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 915 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The following examples pertain to further embodiments. Specifics in the examples may be used in one or more embodiments.

Example 1 is a method of generating job recommendations, the method comprising: determining, by at least one hardware processor, first regression coefficients and first hidden feature vector jointly for a first layer based on a member's view behavior, and the member's profile; determining, by the at least one hardware processor, second regression coefficients and second hidden feature vector jointly for a second layer based on the first regression coefficients, the first hidden feature vector, and the member's application behavior; and determining, by the at least one hardware processor, a job recommendation based on one or more job profiles, the first regression coefficients, first hidden feature vector, second regression coefficients, and second hidden feature vector.

In Example 2, the subject matter of Example 1 optionally includes determining , by the at least one hardware processor, third regression coefficients and third hidden feature vector jointly for a third layer based on the first regression coefficients, the first hidden feature vector, the second regression coefficients, the second hidden feature vector, and the member's explicit feedback behavior.

In Example 3, the subject matter of Example 2 optionally includes determining, by the at least one hardware processor, the job recommendation based on the one or more job profiles, the first regression coefficients, first hidden feature vector, second regression coefficients, second hidden feature vector, third regression coefficients, and third hidden feature vector; and displaying, on a display communicatively coupled to the at least one hardware processor, the job recommendation to the member on a computer display.

In Example 4, the subject matter of Example 3 optionally includes determining, by the at least one hardware processor, the job recommendation using an iterative Bayesian method to maximize the likelihood that the member will apply to the recommended job.

In Example 5, the subject matter of any one or more of Examples 1-4 optionally include determining, by at least one hardware processor, hidden features based on the member's view behavior and job profiles corresponding to jobs the member viewed; and augmenting, by at least one hardware processor, the member's profile to generate an augmented member's profile with the hidden features.

In Example 6, the subject matter of Example 5 optionally includes determining, by at least one hardware processor, new first regression coefficients based on the augmented member's profile.

In Example 7, the subject matter of any one or more of Examples 1-6 optionally include determining, by at least one hardware processor, hidden features based on the member's application behavior and job profiles corresponding to jobs the member applied to; and augmenting, by at least one hardware processor, the member's profile to generate an augmented member's profile with the hidden features.

In Example 8, the subject matter of Example 7 optionally includes determining, by at least one hardware processor, new second regression coefficients based on the augmented member's profile.

Example 9 is a system comprising: a machine-readable medium storing computer-executable instructions; and at least one hardware processor communicatively coupled to the machine-readable medium that, when the computer-executable instructions are executed, the at least one hardware processor is configured to: determine first regression coefficients and first hidden feature vector jointly for a first layer based on a member's view behavior, and the member's profile; determine second regression coefficients and second hidden feature vector jointly for a second layer based on the first regression coefficients, the first hidden feature vector, and the member's application behavior; and determine a job recommendation based on one or more job profiles, the first regression coefficients, first hidden feature vector, second regression coefficients, and second hidden feature vector.

In Example 10, the subject matter of Example 9 optionally includes wherein the at least one hardware processor is further configured to: determine third regression coefficients and third hidden feature vector jointly for a third layer based on the first regression coefficients, the first hidden feature vector, the second regression coefficients, the second hidden feature vector, and the member's explicit feedback behavior.

In Example 11, the subject matter of any one or more of Examples 9-10 optionally include at least one display communicatively coupled to the hardware processor, wherein the at least one hardware processor is further configured to: determine the job recommendation based on the one or more job profiles, the first regression coefficients, first hidden feature vector, second regression coefficients, second hidden feature vector, third regression coefficients, and third hidden feature vector; and display, on the display, the job recommendation to the member on a computer display.

In Example 12, the subject matter of Example 11 optionally includes wherein the at least one hardware processor is further configured to: determine the job recommendation using an iterative Bayesian method to maximize the likelihood that the member will apply to the recommended job.

In Example 13, the subject matter of any one or more of Examples 9-12 optionally include wherein the at least one hardware processor is further configured to: determine hidden features based on the member's view behavior and job profiles corresponding to jobs the member viewed; and augment the member's profile to generate an augmented member's profile with the hidden features.

In Example 14, the subject matter of Example 13 optionally includes wherein the at least one hardware processor is further configured to: determine new first regression coefficients based on the augmented member's profile.

Example 15 is a machine-readable medium storing computer-executable instructions stored thereon that, when executed by at least one hardware processor, cause the at least one hardware processor to perform a plurality of operations, the operations comprising: determining, by the at least one hardware processor, first regression coefficients and first hidden feature vector jointly for a first layer based on a member's view behavior, and the member's profile; determining, by the at least one hardware processor, second regression coefficients and second hidden feature vector jointly for a second layer based on the first regression coefficients, the first hidden feature vector, and the member's application behavior; and determining, by the at least one hardware processor, a job recommendation based on one or more job profiles, the first regression coefficients, first hidden feature vector, second regression coefficients, and second hidden feature vector.

In Example 16, the subject matter of Example 15 optionally includes wherein the plurality of operations further comprise: determining third regression coefficients and third hidden feature vector jointly for a third layer based on the first regression coefficients, the first hidden feature vector, the second regression coefficients, the second hidden feature vector, and the member's explicit feedback behavior.

In Example 17, the subject matter of Example 16 optionally includes wherein the plurality of operations further comprise: determining, by the at least one hardware processor, the job recommendation based on the one or more job profiles, the first regression coefficients, first hidden feature vector, second regression coefficients, second hidden feature vector, third regression coefficients, and third hidden feature vector; and displaying, on a display communicatively coupled to the at least one hardware processor, the job recommendation to the member on a computer display.

In Example 18, the subject matter of any one or more of Examples 15-17 optionally include wherein the plurality of operations further comprise: determining, by the at least one hardware processor, the job recommendation using an iterative Bayesian method to maximize the likelihood that the member will apply to the recommended job.

In Example 19, the subject matter of any one or more of Examples 15-18 optionally include wherein the plurality of operations further comprise: determining, by at least one hardware processor, hidden features based on the member's view behavior and job profiles corresponding to jobs the member viewed; and augmenting, by at least one hardware processor, the member's profile to generate an augmented member's profile with the hidden features.

In Example 20, the subject matter of Example 19 optionally includes wherein the plurality of operations further comprise: determining, by at least one hardware processor, new first regression coefficients based on the augmented member's profile.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of generating job recommendations, the method comprising:
determining, by at least one hardware processor, first regression coefficients and first hidden feature vector jointly for a first layer based on a member's view behavior, and the member's profile;
determining, by the at least one hardware processor, second regression coefficients and second hidden feature vector jointly for a second layer based on the first regression coefficients, the first hidden feature vector, and the member's application behavior; and
determining, by the at least one hardware processor, a job recommendation based on one or more job profiles, the first regression coefficients, first hidden feature vector, second regression coefficients, and second hidden feature vector.

2. The method of claim 1, further comprising:
determining, by the at least one hardware processor, third regression coefficients and third hidden feature vector jointly for a third layer based on the first regression coefficients, the first hidden feature vector, the second regression coefficients, the second hidden feature vector, and the member's explicit feedback behavior.

3. The method of claim 2, further comprising:
determining, by the at least one hardware processor, the job recommendation based on the one or more job profiles, the first regression coefficients, first hidden feature vector, second regression coefficients, second hidden feature vector, third regression coefficients, and third hidden feature vector; and
displaying, on a display communicatively coupled to the at least one hardware processor, the job recommendation to the member on a computer display.

4. The method of claim 3, further comprising:
determining, by the at least one hardware processor, the job recommendation using an iterative Bayesian method to maximize the likelihood that the member will apply to the recommended job.

5. The method of claim 1, further comprising:
determining, by at least one hardware processor, hidden features based on the member's view behavior and job profiles corresponding to jobs the member viewed; and
augmenting, by at least one hardware processor, the member's profile to generate an augmented member's profile with the hidden features.

6. The method of claim 5, further comprising:
determining, by at least one hardware processor, new first regression coefficients based on the augmented member's profile.

7. The method of claim 1, further comprising:
determining, by at least one hardware processor, hidden features based on the member's application behavior and job profiles corresponding to jobs the member applied to; and
augmenting, by at least one hardware processor, the member's profile to generate an augmented member's profile with the hidden features.

8. The method of claim 7, further comprising:
determining, by at least one hardware processor, new second regression coefficients based on the augmented member's profile.

9. A system comprising:
a machine-readable medium storing computer-executable instructions; and
at least one hardware processor communicatively coupled to the machine-readable medium that, when the computer-executable instructions are executed, the system is configured to:
determine first regression coefficients and first hidden feature vector jointly for a first layer based on a member's view behavior, and the member's profile;
determine second regression coefficients and second hidden feature vector jointly for a second layer based on the first regression coefficients, the first hidden feature vector, and the member's application behavior; and
determine a job recommendation based on one or more job profiles, the first regression coefficients, first hidden feature vector, second regression coefficients, and second hidden feature vector.

10. The system of claim 9, wherein the at least one hardware processor is further configured to:
determine third regression coefficients and third hidden feature vector jointly for a third layer based on the first regression coefficients, the first hidden feature vector, the second regression coefficients, the second hidden feature vector, and the member's explicit feedback behavior.

11. The system of claim 9, further comprising:
at least one display communicatively coupled to the hardware processor, wherein the at least one hardware processor is further configured to:
determine the job recommendation based on the one or more job profiles, the first regression coefficients, first hidden feature vector, second regression coefficients, second hidden feature vector, third regression coefficients, and third hidden feature vector; and
display, on the display, the job recommendation to the member on a computer display.

12. The system of claim 11, wherein the at least one hardware processor is further configured to:
determine the job recommendation using an iterative Bayesian method to maximize the likelihood that the member will apply to the recommended job.

13. The system of claim 9, wherein the at least one hardware processor is further configured to:
determine hidden features based on the member's view behavior and job profiles corresponding to jobs the member viewed; and
augment the member's profile to generate an augmented member's profile with the hidden features.

14. The system of claim 13, wherein the at least one hardware processor is further configured to:
determine new first regression coefficients based on the augmented member's profile.

15. A machine-readable medium storing computer-executable instructions stored thereon that, when executed by at least one hardware processor, cause the at least one hardware processor to perform a plurality of operations, the operations comprising:
determining, by the at least one hardware processor, first regression coefficients and first hidden feature vector jointly for a first layer based on a member's view behavior, and the member's profile;
determining, by the at least one hardware processor, second regression coefficients and second hidden feature vector jointly for a second layer based on the first regression coefficients, the first hidden feature vector, and the member's application behavior; and
determining, by the at least one hardware processor, a job recommendation based on one or more job profiles, the first regression coefficients, first hidden feature vector, second regression coefficients, and second hidden feature vector.

16. The machine-readable medium of claim 15, wherein the plurality of operations further comprise:
determining third regression coefficients and third hidden feature vector jointly for a third layer based on the first regression coefficients, the first hidden feature vector, the second regression coefficients, the second hidden feature vector, and the member's explicit feedback behavior.

17. The machine-readable medium of claim 16, wherein the plurality of operations further comprise:
determining, by the at least one hardware processor, the job recommendation based on the one or more job profiles, the first regression coefficients, first hidden feature vector, second regression coefficients, second hidden feature vector, third regression coefficients, and third hidden feature vector; and
displaying, on a display communicatively coupled to the at least one hardware processor, the job recommendation to the member on a computer display.

18. The machine-readable medium of claim 15, wherein the plurality of operations further comprise:
determining, by the at least one hardware processor, the job recommendation using an iterative Bayesian method to maximize the likelihood that the member will apply to the recommended job.

19. The machine-readable medium of claim 15, wherein the plurality of operations further comprise:
determining, by at least one hardware processor, hidden features based on the member's view behavior and job profiles corresponding to jobs the member viewed; and
augmenting, by at least one hardware processor, the member's profile to generate an augmented member's profile with the hidden features.

20. The machine-readable medium of claim 19, wherein the plurality of operations further comprise:
determining, by at least one hardware processor, new first regression coefficients based on the augmented member's profile.
